(19) United States
(12) Patent Application Publication
(10) Pub. No.: US 2020/0025263 A1
(43) Pub. Date: Jan. 23, 2020

(54) FRICTION PLATE

(71) Applicant: Schaeffler Technologies AG & Co. KG, Herzogenaurach (DE)

(72) Inventor: Fabian Stope, Karlsruhe (DE)

(73) Assignee: Schaeffler Technologies AG & Co. KG, Herzogenaurach (DE)

(21) Appl. No.: 16/336,589

(22) PCT Filed: Oct. 11, 2017
(86) PCT No.: PCT/DE2017/100857

§ 371 Date: Mar. 26, 2019

(30) Foreign Application Priority Data
Nov. 16, 2016 (DE) 10 2016 222 472.7
Feb. 17, 2017 (DE) 10 2017 103 278.9

(51) Int. Cl. F16D 13/64; F16D 13/72; F16D 13/74; F16D 69/04; F16D 69/00

(52) U.S. Cl. CPC F16D 13/648; F16D 13/72; F16D 13/74; F16D 2069/004; F16D 69/00; F16D 2069/0466; F16D 69/0408

(57) ABSTRACT

A friction plate for a wet multiplate clutch includes a carrier element and a friction lining. The friction lining is adhesively bonded to the carrier element, is formed of friction lining pieces, and includes at least four annular sectors. A first one of the at least four annular sectors has a first groove pattern. A second one of the at least four annular sectors has a second groove pattern, different than the first groove pattern.

### CROSS-REFERENCE TO RELATED APPLICATIONS

This application is the United States National Phase of PCT/DE2017/100857 filed Oct. 11, 2017, which claims priority to German Application Nos. DE102017103278.9 filed Feb. 17, 2017 and DE102016222472.7 filed Nov. 16, 2016, the entire disclosures of which are incorporated by reference herein.

### TECHNICAL FIELD

The disclosure relates to a friction plate having friction lining pieces which form a friction lining, in particular for a wet multiplate clutch. The disclosure also relates, where applicable, to a wet multiplate clutch having friction plates of this kind.

### BACKGROUND

European Laid-Open Application EP 0 669 482 A2 discloses a friction lining for a device for torque transmission, in particular a friction clutch, which, to form a friction surface, can be secured on a carrier body and transmits torque to a mating surface. The friction lining is constructed from at least two different porous layers, one of which is secured on the carrier body and forms a porous underlayer comprising a cellulose base containing synthetic fibers and filler material for a likewise porous friction layer secured thereon, which is produced from fibers joined by a thermosetting plastic. The friction layer has a weight of 10 to 120 g/m² and a thickness of 0.02 to 0.3 mm.

German Laid-Open Application DE 10 2009 000 431 A1 discloses a wet multiplate clutch having two or more annular plates arranged in series, against which there is a flow of coolant and which are formed alternately as unlined steel plates and friction-lined plates or as steel plates lined with a friction lining on only one side and which have external and internal toothing formed alternately for connection to an outer and an inner plate carrier. The steel plates each comprise first and second annular friction plates, which are supported on an elastically deformable intermediate ring arranged between them, through which the coolant can pass, and are connected to one another in an axially movable manner at their inner and outer edges while leaving free coolant inlet and outlet openings. The uncoated friction plate(s) is (are) elastically deformable by virtue of a low thickness, wherein the thickness of the elastically deformable and uncoated friction plates is between ten and twenty percent of the plate thickness of conventional solid steel plates.

The German translation DE 603 09 396 T2 of European Patent EP 1 396 655 B1 discloses a friction material having a friction modification layer with a mean thickness of thirty to about two hundred micrometers.

### SUMMARY

Example aspects of the present disclosure include a friction plate having friction lining pieces which form a friction lining, in particular for a wet multiplate clutch, by virtue of the fact that the friction lining is subdivided into at least four annular sectors, at least two of which annular sectors have different groove patterns. A defined arrangement of grooves in the annular sector is referred to as a groove pattern or groove design. The grooves can be stamped grooves, which are provided in friction lining pieces, also referred to as pads. The grooves can be produced in some other way, e.g., by milling. The friction lining pieces or pads are preferably formed from a paper lining. Either way, paper linings are produced in a manner similar to paper. During the production of paper linings, a paper web is produced, for example. The paper linings can be cut out of the paper web. The cut out paper linings then form friction lining pieces or pads.

In an example embodiment, the grooves stamped into the pad or the friction lining piece do not extend as far as the carrier element, to which the friction lining piece or pad is adhesively bonded to form the friction lining. However, a groove pattern can also be formed with a plurality of friction lining pieces which are adhesively bonded to a carrier element and spaced apart from one another. By means of suitable spacings between the friction lining pieces, grooves which extend as far as the carrier element are produced. These grooves advantageously have a greater depth than the stamped grooves. By means of an appropriate shape of the friction linings, it is thus possible to produce similar or even the same groove patterns as when stamping the friction lining pieces or pads.

The carrier element is a carrier plate, for example. The carrier element can be formed integrally or, alternatively, in several parts. According to one aspect of the disclosure, friction lining pieces or pads with overstamped or stamped grooves can be combined with individually adhesively bonded friction lining pieces or pads without overstamping on a friction plate. Inter alia, this provides the advantage that, depending on the operating point of the friction plate, a specific groove pattern or groove design can compensate for disadvantages of another groove pattern or groove design. If the frequency of the operating points is known, the choice of the individual different groove patterns or groove designs and the distribution thereof on the friction plate can be made in accordance with this frequency. Advantages can be obtained from the fact that a certain groove pattern or groove design may be optimal for a certain operating point.

In an example embodiment, the friction lining has at least two types of annular sector with different groove patterns. At least two means that the friction lining can also have more than two, i.e., three, four or more types of annular sector with different groove patterns. In tests or studies performed in the context of the present disclosure, however, significant improvements in the operation of the friction plate were obtained even with two types of annular sector with different groove patterns.

Another example embodiment of the friction plate is characterized in that the at least two types of annular sector with different groove patterns are arranged alternately in the circumferential direction. In the case of two annular sectors with different groove patterns, this means that the groove patterns alternate in the circumferential direction. Where there are more than two types of annular sector with different groove patterns, the same sequence of the different groove patterns in the circumferential direction is preferably maintained.

Another example embodiment of the friction plate is characterized in that in each case at least two adjacent annular sectors have the same groove pattern. This arrangement has proven advantageous at specific operating points in the tests and studies performed in the context of the present disclosure.

Another example embodiment of the friction plate is characterized in that at least two types of annular sector with different groove patterns are arranged in alternate pairs in the circumferential direction. This arrangement too has proven advantageous in respect of specific operating points in the tests and studies performed in the context of the present disclosure.

Another example embodiment of the friction plate is characterized in that the annular sectors all have the same shape and size. This simplifies the production of the friction plate, especially the equipping of carrier elements with friction lining pieces.

According to at least one further embodiment, it is also possible for the annular sectors to have different dimensions in the circumferential direction. Depending on the groove pattern, the annular sectors can also have different dimensions in the radial direction.

Another example embodiment of the friction plate is characterized in that at least one type of annular sector has a stamped groove pattern. In this embodiment, the annular sectors may be formed by precisely one friction lining piece or pad with a stamped or overstamped groove pattern. According to another embodiment, it is also possible for all the types of annular sector to have stamped groove patterns.

Pads or friction lining pieces with an overstamped, stamped or milled structure have a smaller groove cross section, as a result of which the grooves remain filled to a great extent, even at high rotational speeds of the friction plate. This can have the advantageous effect of lowering the temperature of steel plates in the wet multiplate clutch. In contrast, the increased flow resistance of the finer grooves causes overflowing of the cooling medium, i.e., cooling oil, when the friction plate is stationary, leading to a reduction in thermal capacity.

Another example embodiment of the friction plate is characterized in that at least one type of annular sector comprises friction lining pieces which are spaced apart from one another to provide a groove pattern with grooves having a groove bottom formed by a carrier element. It may be advantageous to combine this type of annular sector with the type of annular sector described above having the stamped or overstamped friction lining pieces or pads. According to another embodiment, it is also possible, however, for all the types of annular sector to comprise friction lining pieces which are spaced apart from one another to provide groove patterns with grooves having groove bottoms formed by a carrier element.

In the case of individual adhesively bonded friction lining pieces or pads, all the grooves extend as far as the carrier element, in particular the carrier plate, and are thus in contact with the cooling medium, in particular cooling oil. By virtue of the direct heat transfer from the cooling oil to the carrier element, it is also possible to make use of the thermal mass of the carrier plate, in addition to the steel plate, to lower the temperature level. However, air may flow in through the relatively large groove cross sections, especially at high rotational speeds, and it may be no longer possible to fill the grooves completely with cooling oil. The smaller wetted area resulting therefrom reduces heat dissipation to the cooling oil.

This disadvantage at high rotational speeds is an advantage when the lined plate is stationary since the friction pack with large groove cross sections has a low flow resistance, reducing the risk that a relatively large quantity of cooling oil will build up ahead of the friction pack and will then flow past the friction pack. The cooling oil flowing past thus does not contribute to cooling. In the case of the combination of the annular sectors with stamped grooves and with grooves extending as far as the carrier element, it is possible to compensate for the disadvantageous effects, thus ensuring that only the advantages are brought to bear.

Another example embodiment of the friction plate is characterized in that the annular sectors are spaced apart from one another in the circumferential direction in such a way that a radially extending groove having a groove bottom formed by a or the carrier element is obtained between them in each case. According to one embodiment, a radially extending groove is in each case provided between two annular sectors. According to other embodiments, however, it is also possible for two, three or more annular sectors not to be spaced apart from one another, with the result that there are no radially extending grooves arranged between these annular sectors.

Another example embodiment of the friction plate is characterized in that a number of annular sectors into which the friction lining is subdivided is no greater than a product of an internal radius of the friction plate in centimeter units with the number six. This relationship has proven particularly advantageous to improve the thermal capacity of the friction plates in the tests and studies performed in the context of the present disclosure.

Example aspects of the present disclosure also include a wet multiplate clutch having friction plates which are embodied in the same way as the friction plate described above and which each comprise a carrier element that has a carrier element thickness and on which is mounted at least one friction lining. The friction lining has a friction lining thickness such that a ratio of the friction lining thickness to the carrier element thickness assumes values of between 0.25 and 0.85. The carrier element is, for example, a carrier plate which is provided radially on the inside or radially on the outside with toothing to form a connection for conjoint rotation to a plate carrier of the multiplate clutch.

The carrier element thickness refers to a dimension of the carrier element in an axial direction. The term “axial” refers to an axis of rotation of the multiplate clutch. Axial means in the direction of or parallel to the axis of rotation. Similarly, the term “friction lining thickness” refers to a dimension of the friction lining in the axial direction. The friction lining thickness may vary between 0.25 millimeters and 0.6 millimeters. The carrier plate thickness is obtained from the indicated ratio of the friction lining thickness, divided by the carrier element thickness, and may be between 0.9 millimeters and 0.7 millimeters. In tests and studies performed in the context of the present disclosure, friction lining thicknesses of 0.25; 0.3; 0.4; 0.5; 0.6 and 0.65 millimeters have proven particularly advantageous in the case of carrier elements with a carrier element thickness of 0.9 millimeters; 0.8 millimeters or 0.7 millimeters.

An example embodiment of the wet multiplate clutch is characterized in that the carrier element is provided with friction linings on two mutually opposite sides. The friction linings on the mutually opposite sides of the carrier element may have the same friction lining thickness. The friction linings can be formed integrally or in several parts.

Another example embodiment of the wet multiplate clutch is characterized in that the friction plates are arranged radially and are arranged alternately with mating plates in the axial direction. The mating plates may be embodied as steel plates without friction linings. The term “axial” likewise refers to the axis of rotation of the multiplate clutch. Radial means transverse to the axis of rotation of the multiplate clutch.

An example embodiment is characterized in that the multiplate clutch is embodied as a radial dual clutch with radially nested sub-clutches. In this case, the above-described positive properties of the friction plate are particularly effective.

Another example embodiment of the wet multiplate clutch is characterized in that the multiplate clutch is embodied as an axial dual clutch. The axial dual clutch comprises two sub-clutches embodied as a multiplate clutch, which are arranged offset relative to one another in the axial direction. The sub-clutches are arranged in overlap in the radial direction, i.e., are not nested. This results in a relatively large axial installation space being required by the two sub-clutches in the axial dual clutch. By using the claimed ratio of the friction lining thickness to the carrier element thickness, it is possible to ensure adequate functionality of the dual clutch, even with relatively thin friction linings.

Example aspects of the present disclosure also include a wet multiplate clutch having friction plates which each comprise a carrier element with a carrier element thickness and on which is mounted at least one friction lining, which has a friction lining thickness. In the case of an above-described wet multiplate clutch, the friction lining comprises friction lining pieces between which parallel fluid channels are formed. The friction lining pieces may have relatively small dimensions in the circumferential direction.

The parallel fluid channels may be embodied in such a way as to tend to be wider and/or deeper than conventional grooves. When using relatively small friction lining thicknesses, it is thereby possible to achieve an identical or similar flow rate to that with conventional multiplate clutches. Unwanted negative influences on the functioning of the multiplate clutch in the form of drag torques, inadequate cooling performance, or floating effects, are thereby avoided.

Another example embodiment of the wet multiplate clutch is characterized in that the friction lining pieces extend continuously from the radial inside to the radial outside. Unhindered flow along the carrier element between respective pairs of friction lining pieces is thereby made possible.

Another example embodiment of the wet multiplate clutch is characterized in that the fluid channels extend radially. The term “radial” refers to the axis of rotation of the multiplate clutch. Radial means transverse to the axis of rotation.

Another example embodiment of the wet multiplate clutch is characterized in that the fluid channels are arranged diagonally or on a slope relative to a radial line. The path of the fluid channels may slope in such a way that a fluid, e.g., a coolant or cooling oil, deviates from the radial direction in accordance with a direction of rotation of the plates in order to distribute fluid, especially oil, selectively in the circumferential direction. A larger area covered by the flow can thereby be formed in comparison with a purely radial arrangement of the fluid channels. A compromise between rapid through flow, which is good for low drag torques, and as large as possible an area of the steel plate which is covered by the flow, which improves the cooling effect, can be achieved by means of the angle or a curvature of the fluid channels.

### BRIEF DESCRIPTION OF THE DRAWINGS

Further advantages, features and details of the dislosure will emerge from the following description, in which various illustrative embodiments are described in detail with reference to the drawings. In the drawings:

FIG. 1 shows a simplified section through an axial double clutch having two sub-clutches embodied as multiplate clutches;

FIG. 2 shows an enlarged detail of FIG. 1 having two axially nested plate packs;

FIG. 3 shows a detail view of a friction plate in section;

FIG. 4 shows a simplified illustration of various friction linings for the friction plate from FIG. 3 in plan view;

FIG. 5 shows an enlarged detail of FIG. 4 in section, wherein the illustration is not to scale or is independent of a friction lining thickness; and

FIGS. 6 to 10 show further illustrations of friction linings for the friction plate from FIG. 3 in plan view.

### DETAILED DESCRIPTION

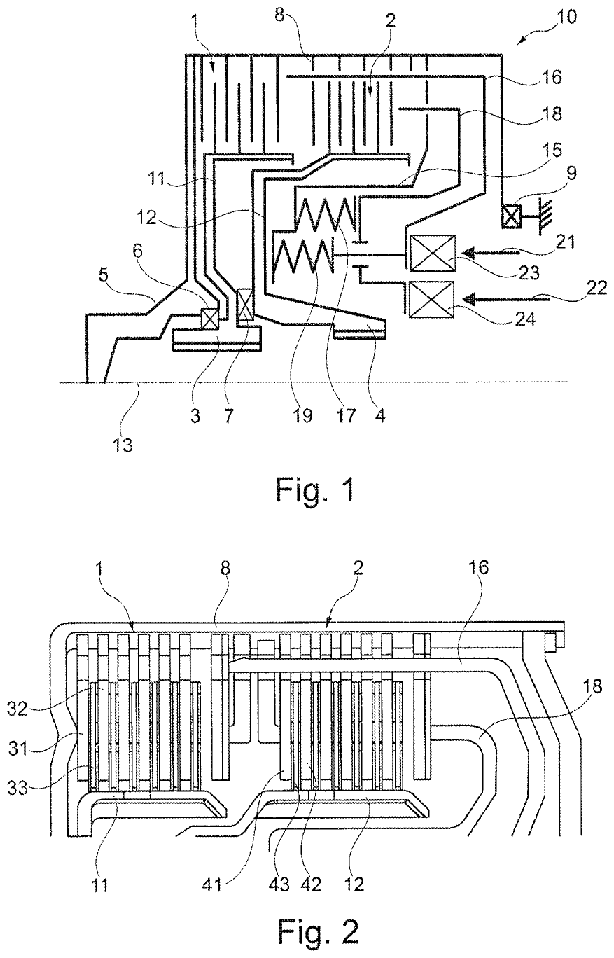

An axial double clutch 10 having two axially nested sub-clutches 1, 2 is illustrated in simplified form in FIG. 1. The sub-clutches 1, 2 are embodied as wet multiplate clutches. “Wet” means that a cooling medium, such as cooling oil, also referred to for short as oil, is fed to the multiplate clutches 1, 2 for cooling.

The multiplate clutch 1 includes a hub 3, which can be connected for conjoint rotation to a transmission input shaft (not shown). The multiplate clutch 2 includes a hub 4, which can be connected for conjoint rotation to a second transmission input shaft (likewise not shown), which is may be embodied as a hollow shaft.

The two multiplate clutches 1, 2 include a common input part 5. The input part 5 is connected for conjoint rotation to a drive shaft (not shown). A bearing device 6 is arranged between the input part 5 and the hub 3 of the multiplate clutch 1. A further bearing device 7 is arranged between the two hubs 3, 4 of the multiplate clutches 1, 2.

The input part 5 of the double clutch 10 is connected for conjoint rotation to a common outer plate carrier 8 for both multiplate clutches 1, 2. The outer plate carrier 8 is rotatably mounted relative to a fixed housing with the aid of a bearing device 9. The fixed housing is indicated only by a symbol at bearing device 9.

The multiplate clutch 1 includes an inner plate carrier 11, which is connected for conjoint rotation to the hub 3. The multiplate clutch 2 includes an inner plate carrier 12, which is connected for conjoint rotation to the hub 4. An axis of rotation of the double clutch 10 is indicated by a chain dotted line 13. The hubs 3, 4 can rotate relative to one another and relative to the outer plate carrier 8 about the axis of rotation 13.

A supporting element 15, which extends radially inward in steps from the outer plate carrier 8, is secured on the outer plate carrier 8. The supporting element 15 is used for the axial support of actuation elements 16, 18 via the spring elements 17, 19.

Actuation element 16 is used to actuate multiplate clutch 1 and extends through a plate pack of multiplate clutch 2. Actuation element 18 is used to actuate multiplate clutch 2.

An arrow 21 indicates an actuating force, which is applied to actuation element 16 via an actuation bearing 23 in order to actuate multiplate clutch 1. An arrow 22 indicates an actuating force, which is applied to actuation element 18 via an actuation bearing 24 in order to actuate multiplate clutch 2.

As indicated by the arrows 21, 22, the axially nested wet double clutch 10 illustrated in simplified form in FIG. 1 is actuated from one side, the side on the right in FIG. 1, with a passage through for the actuation of multiplate clutch 1. In such axial double clutches, in which the individual multiplate clutches 1, 2 are arranged axially in series, the thickness of the individual plates is of decisive importance for managing with the axially available installation space.

In the partial view of FIG. 1 illustrated in FIG. 2, it can be seen that the first multiplate clutch 1 includes a total of seven outer plates 31, 32 and a total of six friction plates 33. The outer plates 31, 32 and the friction plates 33 are arranged alternately in a plate pack in such a way that in each case one friction plate 33 is arranged between two outer plates 31, 32.

Multiplate clutch 2 includes a plate pack with a total of seven outer plates 41, 42 and six friction plates 43 situated axially adjacent to the plate pack of multiplate clutch 1. The outer plates 41, 42 are arranged alternately with the friction plates 43 in the multi-plate pack of multiplate clutch 2 which is on the right in FIG. 2, in precisely the same way as the plates in the plate pack of multiplate clutch 1 which is arranged on the left in FIG. 2.

The outer plates 31, 32 and 41, 42 of the multiplate clutches 1, 2 are embodied as steel plates. The required heat capacity of the steel plates entails a lower limit in the thickness thereof, which, depending on the requirements on the respective clutch, especially as regards the energy input, cannot be exceeded since otherwise the temperatures which arise during the operation of the multiplate clutches 1, 2 would assume values that are too high.

Limits are likewise imposed by dimensional accuracy, in particular flatness due to undulation/conicity, e.g., in the handling of the parts during assembly, especially as regards susceptibility to accidental bending, or the stiffness of the plates, which has an effect on the pressure distribution in the plate pack.

The outer plates 31, 32; 41, 42 of the multiplate clutches 1; 2 are provided with external teeth, which are used to form a connection for conjoint rotation to the common outer plate carrier 8. The friction plates 33; 43 of the multiplate clutches 1; 2 are provided with internal teeth, which are used to form a connection for conjoint rotation to the associated inner plate carrier 11; 12.

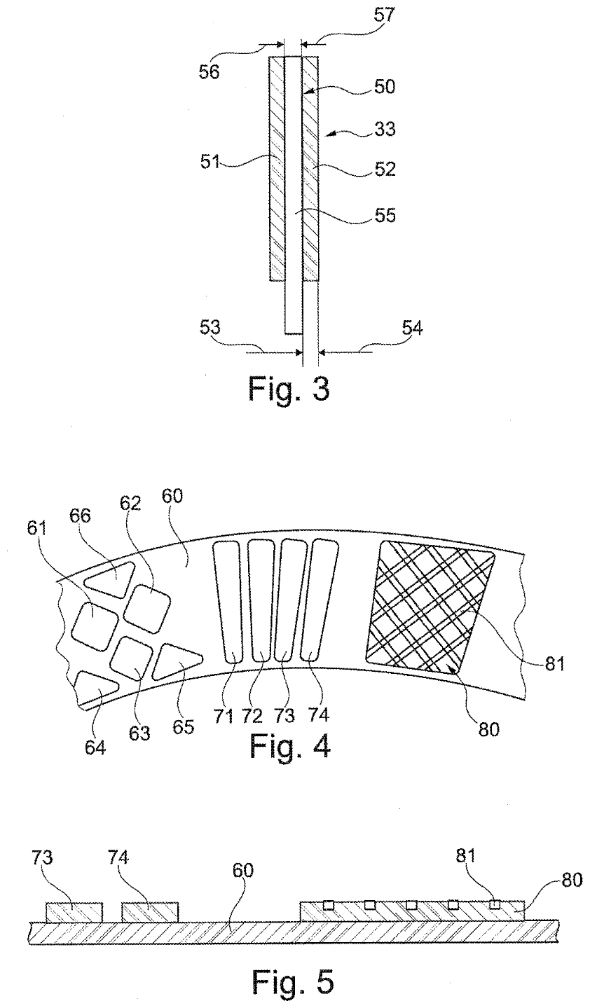

The friction plate 33 from FIG. 2 is illustrated in cross section on an enlarged scale in FIG. 3. The friction plate 33 includes a carrier element 50, which is fitted with friction linings 51, 52 on two mutually opposite sides. The friction linings 51, 52 can be formed integrally or in several parts.

The friction linings 51, 52 are preferably paper linings. The paper linings 51, 52 are firmly connected in a materially integral manner, e.g., by adhesive bonding, to the carrier element 50. A thickness of friction lining 52 is denoted by arrow 53, 54.

The carrier element 50 is embodied, for example, as a carrier plate 55 with a defined thickness, as indicated by arrows 56, 57. Radially on the inside, carrier plate 55 is advantageously equipped with internal toothing, which is used for connection for conjoint rotation to the inner plate carrier (11 in FIG. 2) of the multiplate clutch.

As for the steel plates, i.e. the outer plates 31, 32; 41, 42, there are likewise lower limits for the thickness of the carrier elements 50, in particular carrier plates 55, especially as regards surface pressure at the tooth contact. The lining thickness 53, 54 of the friction lining 52 furthermore has an effect on the drag torques which occur during operation. Moreover, the lining thickness 53, 54 of friction lining 52 is a decisive parameter for oil flow occurring through the lining grooves during the operation of the multiplate clutch.

In multiplate clutches, the oil flow from radially on the inside to radially on the outside is inherent in the principle involved and results from the inertia of the oil and from the rotation of the clutch components, which take the oil along and impart to it a rotary motion. Here, the oil is part of a tribological system of the multiplate clutch together with the friction lining, which is usually formed from paper, and the mating plates or outer plates, which are usually embodied as steel plates.

Conventional friction linings have a thickness of 0.75 millimeters, for example. In order to save axial installation space, it is possible to reduce the friction lining thickness, in particular paper thickness, if, by way of compensation, the groove design or lining pattern of the groove is modified in such a way that the trend is toward the provision of wider and/or deeper grooves in order to avoid significantly restricting the flow cross sections since this, in turn, could have a negative effect on the operation of the multiplate clutch, especially as regards drag torques, cooling behavior, floating effects and friction coefficient behavior.

In the context of the present invention, tests and studies have been carried out to determine how an optimum ratio of the lining thickness on one side, in particular the friction lining thickness 53, 54, to the thickness 56, 57 of the carrier plate 55 can be optimized. In the process, it has been found that a ratio of the friction lining thickness 53, 54 to the carrier plate thickness 56, 57 of 0.25 to 0.85 is the optimum. In specific applications, this ratio makes it possible to ensure that a double clutch can be implemented in an available installation space. Depending on the number of plates, it is possible, by maintaining the optimum ratio, to save installation space totaling several millimeters.

A detail of a carrier element 60 is illustrated in plan view and in section in FIGS. 4 and 5. The carrier element 60 is a carrier plate of the kind denoted by 55 in FIG. 3, for example. To illustrate friction lining grooving, friction lining pieces 61 to 66; 71 to 74 and 80 are mounted on the carrier element 60. The friction lining pieces 61 to 66; 71 to 74 and 80 are preferably firmly connected in a materially integral manner, in particular by adhesive bonding, to the carrier element 60.

Friction lining pieces 61 to 63 are of substantially diamond-shaped design. Friction lining pieces 64 to 66 are of substantially triangular design. Here, friction lining pieces 61 to 66 are provided with rounded edges.

Parallel fluid channels are formed between friction lining pieces 61 to 66. The fluid channels are delimited by the carrier element 60 and friction lining pieces 61 to 66 and extend parallel to one another. The fluid channels are also referred to as grooves.

As regards the groove design, it should in principle be ensured that an adequate flow cross section for the required cooling oil volume flow is formed to enable said cooling oil to flow through the plate pack without flowing past or building up and promoting unwanted floating of the friction linings.

Various groove designs are shown by way of example in FIG. 4. Friction lining piece 80 is relatively large and is provided with a stamped groove pattern 81, which is referred to as a waffle pattern. Compared with the waffle pattern 81 with large friction lining pieces, which are also referred to as individual pads, in which the waffle pattern is merely stamped, i.e., the waffle grooves have only a small groove depth, a groove design with smaller or narrower friction lining pieces or individual pads is preferable when using very thin friction linings. In this case, overstamping does not necessarily have to take place since the individual pads already have a sufficiently small area and, in terms of their depth, the intermediate regions/grooves always extend as far as the carrier element 60.

Thus, the flow cross section of the oil can be maintained despite the relatively thin lining, advantageously while simultaneously keeping the proportion accounted for by grooves unchanged. The proportion accounted for by grooves designates the proportion of the total annular area of the friction linings which has grooves or which does not come into contact with the steel plate.

Since the surface pressure at the friction contact between the friction lining and the steel plates cannot be increased arbitrarily, the proportion accounted for by grooves must be approximately maintained, even in the case of relatively thin friction linings. Otherwise, an unwanted temperature increase at the friction contact would be the result or it would be necessary to enlarge the annular surface, which, in turn, would entail disadvantages in respect of the radial installation space.

The groove pattern formed by friction lining pieces 61 to 66 is also referred to as a rain tire pattern. This rain tire pattern has proven advantageous in combination with the claimed ratio of the friction lining thickness to the carrier plate thickness of 0.25 to 0.85.

As an alternative, a groove pattern with the narrower friction lining pieces 70 to 74 has proven advantageous. In this case, the profile of the grooving or of the pads or friction lining pieces 71 to 74 can also deviate from the radially outward direction and can slope, for example.

The slope relative to the radial direction may be dependent on a direction of rotation of the plates. By means of the appropriate slope, oil can also be distributed selectively in the circumferential direction in order to achieve an improved cooling performance by means of a larger surface over which flow occurs.

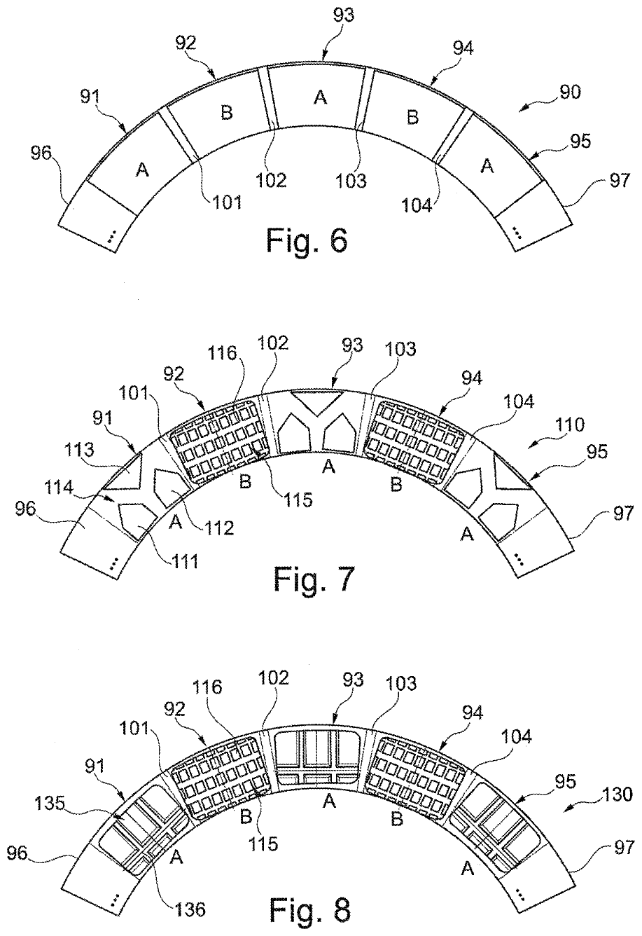

Various illustrative embodiments of friction linings 90; 110; 130; 140; 160 for a friction plate of the kind illustrated in FIG. 3 and denoted by 33 are illustrated in FIGS. 6 to 10. The friction lining has the form of a circular ring with an internal radius and an external radius. The carrier element (55 in FIG. 3) of the friction plate (33 in FIG. 3) can have the same friction lining 90; 110; 130; 140; 160 on each of the two sides. However, it is also possible for different friction linings 90; 110; 130; 140; 160 to be arranged on the sides of the carrier element (55 in FIG. 3).

The different friction linings 90; 110; 130; 140; 160 are subdivided over their entire circumference into annular sectors 91 to 95. Annular sectors 96, 97 with three dots indicate that the arrangement of the annular sectors 91 to 95 which is shown in FIGS. 6 to 10 is continued over the entire circumference of the friction lining 90; 110; 130; 140; 160.

Annular sectors 91 to 95 all have the same shape and the same size. A radially extending groove 101, 102, 103, 104 is arranged between each of two annular sectors 91, 92; 92, 93; 93, 94; 94, 95. The grooves 101 to 104 extend as far as the carrier element (55 in FIG. 3).

Capital letters A, B, A, B, A in FIGS. 6 to 9 are used to indicate that the annular sectors 91 to 95 have different groove patterns alternately in the circumferential direction. Thus, any desired groove pattern or groove design or lining design A and B can be combined.

In the case of the friction lining 110 illustrated in FIG. 7, the annular sectors 91, 93, 95 have groove pattern A. In FIG. 7, groove pattern or groove design A is formed in each case by three friction lining pieces 111, 112, 113. Friction lining pieces 111 to 113 are configured and arranged in such a way that the groove pattern 114 obtained has grooves which extend as far as the carrier element or carrier plate (55 in FIG. 3). The groove pattern 114 is also referred to as a rain tire design.

Annular sectors 92, 94 each include just one friction lining piece or pad 115 with a stamped groove pattern 116. The stamped groove pattern 116 can also be referred to as a micro-waffle design. The grooves in groove pattern 116 are only stamped and do not extend as far as the carrier element.

In the case of the friction lining 130 illustrated in FIG. 8, the groove pattern 116 from FIG. 7 is combined with a groove pattern 136 stamped in each case into a friction lining piece 135. The groove pattern 136 is also referred to as a waffle design. Waffle design 136 includes significantly larger rectangles than the micro-waffle design 116.

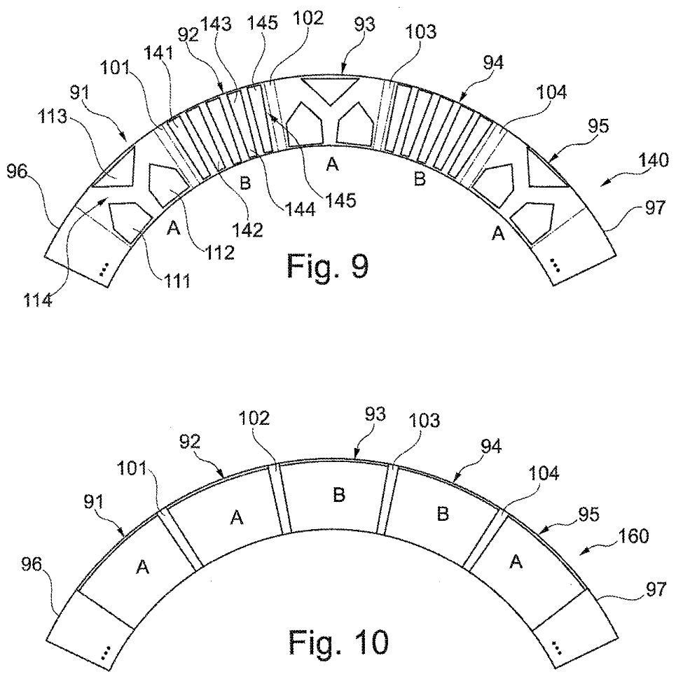

In the case of the friction lining 140 illustrated in FIG. 9, the rain tire design 114 from FIG. 7 is combined with a groove pattern 145 in annular sectors 92, 94. Groove pattern 145 is formed by friction lining pieces 141 to 144, which have substantially the shape of annular sectors but have only a small extent in the circumferential direction. A radial groove is in each case left between respective pairs of friction lining pieces 141, 142; 142, 143; 143, 144. Like the radial grooves 101, 102 and 103, 104 adjacent to annular sectors 92 and 94, the radial grooves extend as far as the carrier element.

FIG. 10 indicates that the annular sectors 91, 92; 93, 94; etc. can also have the same paired groove patterns A, A; B, B. Groove pattern 114 or 116 can be used for groove pattern A, for example. Groove pattern 136 or 145 can be used for groove pattern B, for example.

The friction linings 90; 110; 130; 140; 160 have a lining thickness of 0.5 or 0.8 millimeters, for example. Each friction lining 90; 110; 130; 140; 160 includes at least four annular sectors 91 to 95. A maximum number of the annular sectors 91 to 95 depends on the radius, especially the internal radius, of the friction linings 90; 110; 130; 140; 160. The annular sectors 91 to 95 advantageously have an extent of at least ten millimeters in the circumferential direction.

### REFERENCE LABELS

1 multiplate clutch

2 multiplate clutch

3 hub

4 hub

5 input part

6 bearing device

7 bearing device

8 outer plate carrier

9 bearing device

10 double clutch

11 inner plate carrier

12 inner plate carrier

13 axis of rotation

15 supporting element

16 actuation element

17 spring element

18 actuation element

19 spring element

21 arrow

22 arrow

23 actuation bearing

24 actuation bearing

31 outer plate

32 outer plate

33 friction plate

41 outer plate

42 outer plate

43 friction plate

50 carrier element

51 friction lining

52 friction lining

53 arrow

54 arrow

55 carrier plate

56 arrow

57 arrow

60 carrier element

61 friction lining piece

62 friction lining piece

63 friction lining piece

64 friction lining piece

65 friction lining piece

66 friction lining piece

71 friction lining piece

72 friction lining piece

73 friction lining piece

74 friction lining piece

80 friction lining piece

81 groove pattern

90 friction lining

91 annular sector

92 annular sector

93 annular sector

94 annular sector

95 annular sector

101 groove

102 groove

103 groove

104 groove

110 friction lining

111 friction lining piece

112 friction lining piece

113 friction lining piece

114 groove pattern

115 friction lining piece

116 groove pattern

130 friction lining

135 friction lining piece

136 groove pattern

140 friction lining

141 friction lining piece

142 friction lining piece

143 friction lining piece

144 friction lining piece

145 groove pattern

160 friction lining

1-10. (canceled)

11. A friction plate for a wet multiplate clutch comprising:
a carrier element; and,
a friction lining, adhesively bonded to the carrier element, formed of friction lining pieces, and including at least four annular sectors, wherein:
a first one of the at least four annular sectors comprises a first groove pattern; and,
a second one of the at least four annular sectors comprises a second groove pattern, different than the first groove pattern.

12. The friction plate of claim 11, wherein the at least four annular sectors comprises:
a first type of annular sector with a first groove pattern; and,
a second type of annular sector with a second groove pattern, different than the first groove pattern.

13. The friction plate of claim 12, wherein the first type of annular sector is arranged alternately with the second type of annular sector in a circumferential direction in an A, B, A, B pattern where A denotes the first type of annular sector and B denotes the second type of annular sector.

14. The friction plate of claim 12, wherein a first one of the first type of annular sector is adjacent to a second one of the first type of annular sector.

15. The friction plate of claim 14, wherein pairs of the first type of annular sector are arranged alternately with pairs of the second type of annular sector in a circumferential direction in an A, A, B, B pattern where A denotes the first type of annular sector and B denotes the second type of annular sector.

16. The friction plate of claim 11 wherein each one of the at least four annular sectors has the same shape and size as the other ones of the at least four annular sectors.

17. The friction plate of claim 11, wherein the first one of the at least four annular sectors comprises a stamped groove pattern.

18. The friction plate of claim 11 wherein the first one of the at least four annular sectors comprises a plurality of the friction lining pieces spaced apart from one another to form a groove pattern having grooves with groove bottoms formed by the carrier element.

19. The friction plate of claim 11, wherein each one of the at least four annular sectors is spaced apart from the other ones of the at least four annular sectors in a circumferential direction to form a radially extending groove having a groove bottom formed by the carrier element between pairs of the at least four annular sectors.

20. The friction plate of claim 11, wherein a quantity of the at least four annular sectors is less than or equal to six times an internal radius of the friction plate in centimeter units.

21. A friction plate comprising:
a carrier plate including a first plurality of annular sectors;
a first friction lining arranged on a first one of the first plurality of annular sectors and including a first groove pattern; and,
a second friction lining arranged on a second one of the first plurality of annular sectors and including a second groove pattern, different than the first groove pattern.

22. The friction plate of claim 21 wherein the first friction lining is a first plurality of friction lining pieces and the first groove pattern is formed as grooves between each one of the first plurality of friction lining pieces.

23. The friction plate of claim 22 wherein the first groove pattern is a rain tire design.

24. The friction plate of claim 23 wherein the second friction lining is a second plurality of friction lining pieces and the second groove pattern is formed as radial grooves between each one of the second plurality of friction lining pieces.

25. The friction plate of claim 22 wherein the second friction lining is a single friction lining piece and the second groove pattern is a stamped waffle design or a stamped micro waffle design.

26. The friction plate of claim 21 wherein:
the first friction lining is a single friction lining piece and the first groove pattern is a stamped groove pattern; and,
the second friction lining is a single friction lining piece and the second groove pattern is a stamped groove pattern.

27. The friction plate of claim 26 wherein the first groove pattern is a waffle design and the second groove pattern is a micro waffle design.

28. The friction plate of claim 21 wherein the first friction lining and the second friction lining are arranged on the first plurality of annular sectors in an A,B,A,B pattern or an A,A,B,B pattern where A denotes the first friction lining and B denotes the second friction lining.

29. The friction plate of claim 21 wherein the first friction lining and the second friction lining are affixed to the first plurality of annular sectors by adhesive bonding.

30. The friction plate of claim 21 wherein:
the carrier plate comprises a first axial side and a second axial side;
the first plurality of annular sectors is disposed on the first axial side;
a second plurality of annular sectors is disposed on the second axial side; and, the friction plate comprises:
a third friction lining arranged on a first one of the second plurality of annular sectors and including a third groove pattern; and,
a fourth friction lining arranged on a second one of the second plurality of annular sectors and including a fourth groove pattern, different than the third groove pattern.
